(19) United States
(12) Patent Application Publication
(10) Pub. No.: US 2014/0310699 A1
(43) Pub. Date: Oct. 16, 2014

(54) Method And Apparatus For Upgrading A Plug-In Based On An Instant Messaging Application

(71) Applicant: TENCENT TECHNOLOGY (SHENZHEN) COMPANY LIMITED, SHENZHEN (CN)

(72) Inventors: Zurong WU, Shenzhen City (CN); Yehui LIN, Shenzhen City (CN); Hui SUN, Shenzhen City (CN); Jun LUO, Shenzhen City (CN)

(21) Appl. No.: 14/314,063

(22) Filed: Jun. 25, 2014

Related U.S. Application Data
(63) Continuation of application No. PCT/CN2012/086526, filed on Dec. 13, 2012.

(30) Foreign Application Priority Data
Dec. 26, 2011 (CN) 201110441057.1

(51) Int. Cl. G06F 9/445; G06F 9/44; H04W 4/12

(52) U.S. Cl. CPC G06F 8/65; H04W 4/12; G06F 8/71
USPC 717/170

(57) ABSTRACT

A method and an apparatus for upgrading a plug-in based on an IM application. The method includes obtaining basic elements of an IM application with a version called by a plug-in to be upgraded to the IM application. A client is scanned to obtain basic elements of an IM application in the client. The method also includes comparing, according to a type of a basic element, the basic elements of the IM application with the version called by the plug-in to be upgraded with the basic elements of the IM application in the client. A client matching the basic elements of the IM application with the version called by the plug-in to be upgraded is determined. The plug-in to be upgraded is released to the matched client.

### CROSS-REFERENCE TO RELATED APPLICATIONS

This application is a continuation of International Application No. PCT/CN2012/086526 filed on Dec. 13, 2012. This application claims the benefit and priority of Chinese Application No. CN201110441057.1 filed Dec. 26, 2011. The entire disclosures of each of the above applications are incorporated herein by reference.

### FIELD

The present disclosure relates to Instant Messaging (IM) technology, and more particularly, to a method and an apparatus for upgrading a plug-in based on an IM application.

### BACKGROUND

This section provides background information related to the present disclosure which is not necessarily prior art.

With the development of computing network technology and the third generation (3G) mobile communication internet technology, it is popular to implement, through the peer to peer technique, functions of an IM application providing real-time communication on the internet. The IM application has been accepted by most users, and has become an essential part of the user's daily lives and work communications. With the popularity of the IM application, a single internet service, i.e., a chat function, in prior IM applications does not meet the diverse demands of users. More and more operators are beginning to satisfy the diverse demands of the users and to expand businesses at the same time in such a manner that various internet services, including both cost services and free services, are hosted on the IM application to construct a plug-in of the IM application. The user may install the plug-in of the IM application, in which the plug-in may be presented in the form of a binary dynamic link library (DLL), and the user may then obtain an internet service provided by the plug-in through the IM application. A QQ software, which is an IM application, may be taken as an example. The QQ software is used as a platform for popularizing various services of the Tencent Co., Ltd. A plurality of internet services and portals are hosted on the QQ software, such as a QQ member function, a QQ yellow diamond function, one key to enter a QQ mailbox, one key to enter a QQ space, etc. These functions and portals may provide convenience for the user to experience various internet services provided by the Tencent Co., Ltd. through the QQ software.

Conventionally, the various cost or free internet services hosted on the IM application, i.e., the plug-ins of the IM application, are encapsulated in the IM application and are downloaded and installed together with the IM application. If the operators want to upgrade the plug-in of the IM application, for example, to popularize a new cost or free internet service, an upgraded plug-in may be re-encapsulated in an original IM application or in an upgraded IM application, and then may be released to public. As such, after the user downloads the plug-in of the IM application that hosts the new internet service and successfully installs the plug-in, the user may experience the new internet service hosed on the IM application.

As may be seen from the above description, in the conventional way of upgrading the plug-in based on the IM application the upgraded plug-in is encapsulated in the IM application and the user may experience the new internet service hosted on the IM application through installing the plug-in of the IM application. As such, even for the same IM application, as long as an internet service hosted on the IM application is upgraded, a plug-in of the IM application hosting the new internet service may be re-downloaded; therefore, the service coverage of the same IM application may be lower, operations of obtaining the new internet service may be cumbersome, network traffic may be excessive, and the user costs may be increased.

### SUMMARY

This section provides a general summary of the disclosure, and is not a comprehensive disclosure of its full scope or all of its features.

In one aspect of the present disclosure, a method for upgrading a plug-in based on an instant messaging (IM) application is provided, which includes:

obtaining basic elements of an IM application with a version called by a plug-in to be upgraded of the IM application;

obtaining basic elements of an IM application in a client;

comparing, according to a type of a basic element, the basic elements of the IM application with the version called by the plug-in to be upgraded with the basic elements of the IM application in the client;

determining a client matching the basic elements of the IM application with the version called by the plug-in to be upgraded; and

releasing the plug-in to be upgraded to the matched client.

In another aspect of the present disclosure, an apparatus for upgrading a plug-in based on an instant messaging (IM) application is provided, which includes:

an obtaining module, to obtain basic elements of an IM application with a version called by a plug-in to be upgraded to the IM application;

a scanning module, to obtain basic elements of an IM application in a client;

a matching module, to compare, according to a type of a basic element, the basic elements of the IM application with the version called by the plug-in to be upgraded with the basic elements of the IM application in the client, and to determine a client matching the basic elements of the IM application with the version called by the plug-in to be upgraded; and

a releasing module, to release the plug-in to be upgraded to the matched client.

In another aspect of the present disclosure, a non-transitory computer readable storage medium is provided. The non-transitory computer readable storage medium stores one or more programs, which include instructions that, when executed by one or more computers, cause the one or more computers to perform operations including:

obtaining basic elements of an IM application with a version called by a plug-in to be upgraded to the IM application;

obtaining basic elements of an IM application in a client;

comparing, according to a type of a basic element, the basic elements of the IM application with the version called by the plug-in to be upgraded with the basic elements of the IM application in the client;

determining a client matching the basic elements of the IM application with the version called by the plug-in to be upgraded; and

releasing the plug-in to be upgraded to the matched client.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram illustrating a relationship between a plug-in and an IM application platform, according to various embodiments of the present disclosure.

FIG. 2 is a flowchart illustrating a method for upgrading a plug-in based on an IM application, according to various embodiments of the present disclosure.

FIG. 3 is a diagram illustrating a structure of an apparatus for upgrading a plug-in based on an IM application, according to various embodiments of the present disclosure.

FIG. 4 is a diagram illustrating a structure of an apparatus for upgrading a plug-in based on an IM application, according to various embodiments of the present disclosure.

Corresponding reference numerals indicate corresponding parts throughout the several views of the drawings.

### DETAILED DESCRIPTION

Example embodiments will now be described more fully with reference to the accompanying drawings.

Hereinafter, the present disclosure will be described in further detail with reference to the accompanying drawings and exemplary examples.

In the conventional way of upgrading a plug-in based on an IM application, a new service function such as a new cost or free internet service may be hosted on an updated or upgraded IM application for utilization. Only when a user downloads and installs the latest version of the IM application hosting the new internet service can the user experience the new internet service hosted on the IM application. By this manner, the service coverage of the IM application is lower, and the operations of obtaining the new internet service are cumbersome. Moreover, if the new internet service is encapsulated into the latest version of the IM application, a user who still uses an old version of the IM application cannot experience the new internet service without installing the IM application with the latest version.

Examples of the present disclosure provide a solution for upgrading a plug-in of an IM application, in which the plug-in may not be released along with the IM application with the latest version, and a service (e.g., an internet service, a plug-in) may be directly connected, in the form of an independent plug-in DLL, to the IM application with an old version that has been already released to public. In other words, a new internet service to be released (or to be upgraded) may not be encapsulated into the IM application with the latest version, but may be directly connected, in the form of the independent plug-in, to the IM application with the old version that has been already released to the public.

As described above, considering that a plug-in of an IM application may be presented as a binary DLL, the various internet services may be implemented through calling a public infrastructure service provided by the IM application, and may be provided to the user for operation. A function of each plug-in may be independent. The public infrastructure service provided by the IM application may include a data structure, a network service, a file system, etc. When the public infrastructure service is mapped to machine readable instructions, what is presented may be the result of basic elements, which may include an export function, an interface, an enumeration value, and a struct. After analyzing data structures, network services, and file systems provided by IM applications with different purposes, it may be recognized that identical machine readable instructions may not exist in machine readable instructions of export functions, interfaces, enumeration values, and structs of the IM applications with the different types, and machine readable instructions corresponding to IM applications with a same type may not necessarily be identical. For example, an export function of an IM application with type A is different from an export function of an IM application with type B. Moreover, an interface, an enumeration value, and a struct of the IM application with type A may respectively be different from an interface, an enumeration value, and a struct of the IM application with type B.

A client in examples of the present disclosure may include but not be limited to IM client software operated by a user and a hardware platform with an IM function, such as a computer, a smart phone, a personal digital assistant, etc.

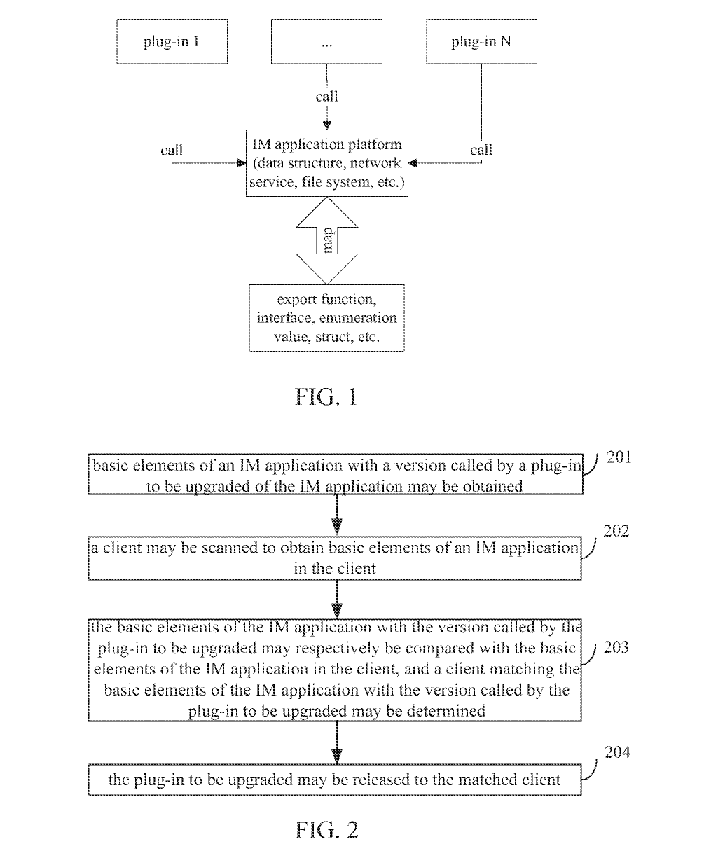

FIG. 1 is a diagram illustrating a relationship between a plug-in and an IM application platform, according to various embodiments of the present disclosure. With reference to FIG. 1, each plug-in may retrieve a data structure, a network service, and a file system provided by the IM application platform. In this case, what is presented when the data structure is mapped to the machine readable instructions may be the retrieval of an export function. What is presented when the network service is mapped to the machine readable instructions may be the retrieval of an interface. What is presented when the file system is mapped to the machine readable instructions may be the retrieval of an enumeration value and a struct. As such, an internet service provided by the plug-in may be achieved through the retrieval of the export function, the retrieval of the interface, and the retrieval of the enumeration value and the struct.

As such, in one regard, if the internet service is hosted on the IM applications with the same type, the retrieved basic elements provided by the IM applications may be the same. Therefore, in examples of the present disclosure, if basic elements of an IM application with a version that may be called by an internet service plug-in to be upgraded are the same as basic elements of an IM application with a released version, the plug-in to be upgraded may be pushed to the IM application with the released version. By this manner, the user may experience the new internet service without installing the IM application with the latest version, and the service coverage of the IM application may be improved. Further, the operations of obtaining the new internet service may be simplified because the plug-in to be upgraded may not be necessary and the user may not need to download the plug-in of the IM application.

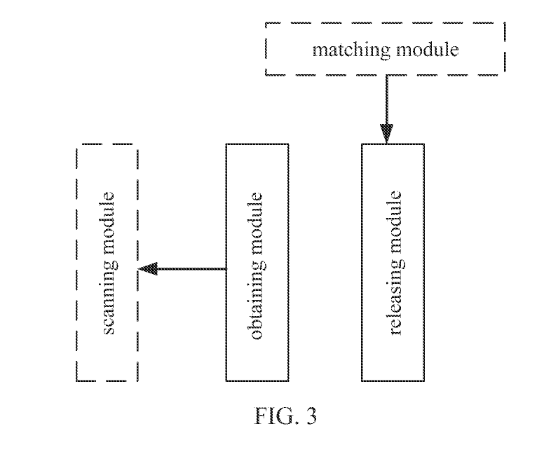

FIG. 2 is a flowchart illustrating a method for upgrading a plug-in based on an IM application, according to various embodiments of the present disclosure. As shown in FIG. 2, the method may include the following operations.

In block 201, basic elements of an IM application with a version called by a plug-in to be upgraded of the IM application may be obtained.

In this case, the operator may decide to upgrade the plug-in according to actual requirements, and may determine the IM application that may host the plug-in to be upgraded. In other words, after the IM application with the version called by the plug-in to be upgraded is determined, a server may obtain the basic elements of the IM application with the version called by the plug-in to be upgraded.

In various embodiments of the present disclosure, the plug-in to be upgraded may also be encapsulated into the IM application with the latest version to form an IM application for using subsequently.

In various embodiments of the present disclosure, the basic elements may include an export function, an interface, an enumeration value, and a struct. The export function may be associated with a binary DLL, while the interface, the enumeration value and the struct may be associated with source machine readable instructions.

In various embodiments of the present disclosure, the operation of obtaining the export function in the basic elements may include the following processes.

In process A1, the server may be scanned to obtain a DLL file in the IM application.

In this process, a scanning function (e.g., a SnapExpFun function) may be called to scan a DLL file in the server, so as to obtain the DLL file in the IM application.

In process A2, a structure of a portable execute (PE) file in the DLL file of the IM application may be analyzed to extract information from an export table in the structure, so as to obtain the export function.

In various embodiments of the present disclosure, the operation of obtaining the interface, the enumeration value, and the struct in the basic elements may include scanning, using an automatic interface of a Microsoft data terminal equipment (DTE) in the server, all files of the IM application in the server, and obtaining the interface, the enumeration value, and the struct.

In this case, all of the files in the IM application may be scanned through a source code scanning function (e.g., a SnapAddin function) to obtain the interface, the enumeration value, and the struct.

After obtaining the basic elements, the method may further include storing the obtained basic elements. For example, the obtained basic elements may be stored in a MySQL database.

In block 202, a client may be scanned to obtain basic elements of an IM application in the client.

In this case, according to information of the plug-in to be upgraded, all clients connected to the server may be traversed to obtain basic elements of each IM application in each client. A way for obtaining the basic elements may be the same as the operations in block 201.

Similarly, after obtaining the basic elements of the IM application in the client, the obtained basic elements of the IM application in the client and identifier information of the client may be stored.

In block 203, the basic elements of the IM application with the version called by the plug-in to be upgraded may respectively be compared with the basic elements of the IM application in the client, and a client matching the basic elements of the IM application with the version called by the plug-in to be upgraded may be determined.

In this case, the matching process may be defined to mean a comparison of the basic elements of the IM application with the version called by the plug-in to be upgraded with the basic elements of the IM application with a released version. In various embodiments of the present disclosure, the basic elements of the IM application with the version called by the plug-in to be upgraded including the export function, the interface, the enumeration value, and the struct, may respectively be compared with the export function, the interface, the enumeration value, and the struct of the IM application with the released version. If the basic elements of the IM application with the version called by the plug-in to be upgraded are the same as the basic elements of the IM application with the released version, respectively, it may be determined that cross-version upgrading may be performed to the plug-in to be upgraded. According to the IM application with the released version matching the IM application with the version called by the plug-in to be upgraded, information about a client, on which the IM application with the released version is stalled, may be obtained, and a process for upgrading the plug-in may be initiated with the identified client.

As mentioned above, the basic elements to be compared have been previously stored in the database, thus, the basic elements of the IM application with the version called by the plug-in to be upgraded may be obtained from the database, and may respectively be compared with the basic elements of the IM application in each client. A matching process may occur, as long as any one of the basic elements of the IM application with the version called by the plug-in to be upgraded is different from the corresponding basic elements of the IM application in the client. The plug-in to be upgraded may not be upgraded on the client that may match the plug-in to be upgraded and may install the IM application with the released version. Otherwise, if all of the basic elements of the IM application with the version called by the plug-in to be upgraded are respectively the same as the basic elements of the IM application in the client, the upgrading may be allowable.

In various embodiments of the present disclosure, the matching process may be closely associated with a type of a basic element. For example, whether or not the match of the export functions in the IM applications of the two versions is successful may be determined based on the match of four parameters of the export function, including a function name, a return value, the number of parameters, and a parameter type. If all of the parameters of the export functions in the IM applications of the two versions are the same, the match of the export functions may be successful.

In various embodiments of the present disclosure, for the interface, a name of the interface may be compared first. If the names of the interfaces in the IM applications of the two versions are the same, a member function of the interface may be further compared. If the member functions of the interfaces in the IM applications of the two versions are the same, the match of the interfaces may be successful.

In various embodiments of the present disclosure, whether the match of the enumeration values in the IM applications of the two versions is successful may be determined based on the match of a position and a value of an enumeration member in the IM applications of the two versions. If the position and the value of the enumeration member in the IM applications of the two versions is respectively the same, the match of the enumeration values may be successful.

In various embodiments of the present disclosure, whether the match of the structs in the IM applications of the two versions is successful may be determined based on the match of three parameters of a struct member including a type, a member name, and a position. If the type, the member name, and the position of the struct member in the IM applications of the two versions are respectively the same, the match of the structs may be successful.

In various embodiments of the present disclosure, the basic elements stored in the MySQL database may be obtained through the utilization of a matching function (e.g., a CodeReporter function) to implement analysis and match.

In block 204, the plug-in to be upgraded may be released to the matched client. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

In this case, the operation of releasing the plug-in to be upgraded to the matched client may include:

sending to the matched client a prompt message about the plug-in to be upgraded;

receiving, from a client, a confirmation message in response to the prompt message about the plug-in to be upgraded; and

sending the plug-in to be upgraded to the client sending the confirmation message.

In various embodiments of the present disclosure, only the plug-in to be upgraded is sent to the client, as such, the plug-in to be upgraded may not be encapsulated into the IM application to form a plug-in of the IM application, and the client may not need to re-install the newly-formed plug-in of the IM application.

In various embodiments of the present disclosure, the plug-in to be upgraded may be directly sent to the matched client, so as to release the plug-in to be upgraded.

In various embodiments of the present disclosure, an installation prompt message about the plug-in to be upgraded may be sent to an unmatched client to prompt the user to download the plug-in of the IM application from the server and to update the IM application installed on the unmatched client. As such, the plug-in to be upgraded may be employed.

FIG. 3 is a diagram illustrating the structure of an apparatus for upgrading a plug-in based on an IM application, according to various embodiments of the present disclosure of the present disclosure. The apparatus may be a server releasing an internet service (e.g., a plug-in), in which the server may be a personal computer. As shown in FIG. 3, the apparatus may include an obtaining module, a scanning module, a matching module, and a releasing module.

In various embodiments of the present disclosure, the obtaining module may obtain basic elements of an IM application with a version called by a plug-in to be upgraded to the IM application.

In various embodiments of the present disclosure, the scanning module may scan each of the clients to obtain basic elements of an IM application in the client. In various embodiments of the present disclosure, the scanning module may call a source code scanning function (e.g., a SnapAddin function) and a scanning function (e.g., a SnapExpFun function), in which the SnapAddin function may scan an interface, an enumeration value, and a struct in the basic elements, and the SnapExpFun function may scan an export function in the basic elements.

In various embodiments of the present disclosure, the matching module may compare, according to a type of the basic element, each of the basic elements of the IM application with the version called by the plug-in to be upgraded with each of the basic elements of the IM application in the client, and may determine a client matching the basic elements of the IM application with the version called by the plug-in to be upgraded. In various embodiments of the present disclosure, a matching function (e.g., a CodeReporter function) may be called to obtain the basic elements obtained by the scanning module, to perform analysis and match, and to output a final result email, which may be information about the determined client matching the basic elements of the IM application with the version called by the plug-in to be upgraded.

In various embodiments of the present disclosure, the releasing module may release the plug-in to be upgraded to the IM application to the matched client.

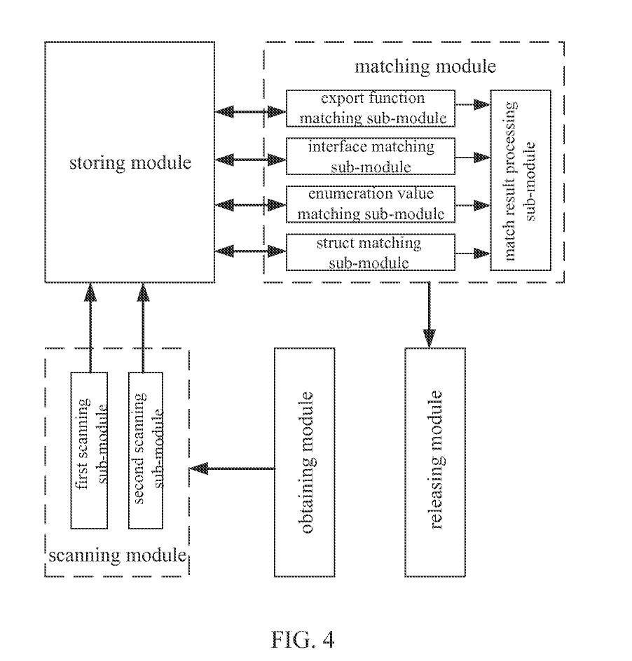

FIG. 4 is a diagram illustrating a structure of the apparatus for upgrading a plug-in based on an IM application, according to various embodiments of the present disclosure. As shown in FIG. 4, the apparatus may further include a storing module, which may store the basic elements of the IM application with the version called by the plug-in to be updated, and may store the basic elements of the IM application in the client and identifier information of the client.

In various embodiments of the present disclosure, the scanning module may include a first scanning sub-module and a second scanning sub-module, in which:

the first scanning sub-module may scan the server and the client to obtain a DLL file in the IM application, analyze a structure of a PE file in the DLL file to extract information from an export table in the structure, and may obtain the export function; and

the second scanning sub-module may traverse the server and the client, scan, using an automatic interface of the Microsoft DTE in the server, all files in the IM application, and obtain the interface, the enumeration value, and the struct.

In various embodiments of the present disclosure, the matching module may include an export function matching sub-module, an interface matching sub-module, an enumeration value matching sub-module, a struct matching sub-module, and a match result processing sub-module, in which:

the export function matching sub-module may obtain, from the storing module, an export function in the basic elements of the IM application with the version called by the plug-in to be upgraded and an export function in the basic elements of the IM application in the client, compare the obtained export functions, and transmit a result of comparing the export functions to the match result processing sub-module;

the interface matching sub-module may obtain, from the storing module, an interface in the basic elements of the IM application with the version called by the plug-in to be upgraded and an interface in the basic elements of the IM application in the client, compare the obtained interfaces, and transmit a result of comparing the interfaces to the match result processing sub-module;

the enumeration value matching sub-module may obtain, from the storing module, an enumeration value in the basic elements of the IM application with the version called by the plug-in to be upgraded and an enumeration value in the basic elements of the IM application in the client, compare the obtained enumeration values, and transmit a result of comparing the enumeration values to the match result processing sub-module;

the struct matching sub-module may obtain, from the storing module, a struct in the basic elements of the IM application with the version called by the plug-in to be upgraded and a struct in the basic elements of the IM application in the client, compare the obtained structs, and transmit a result of comparing the structs to the match result processing sub-module; and

the match result processing sub-module may determine that the received results are all matches, obtain, based on the basic elements of the IM application in the client and the identifier information of the client stored in the storing module, identifier information of a client corresponding to the received results, and may transmit the obtained identifier information to the releasing module.

As may be seen from the above description, various embodiments of the present disclosure may provide a method and an apparatus for upgrading a plug-in based on an IM application, in which basic elements of an IM application with a version called by a plug-in to be upgraded of the IM application and basic elements of an IM application with a released version may be obtained and matched. When the match is successful, the plug-in to be upgraded may be transmitted to a client to which the IM application with the released version belongs. By this manner, the plug-in of the IM application may be upgraded for available versions, and the user may experience the latest service of the IM application without installing the IM application with the latest version. Therefore, the operations of obtaining the new internet service may be simplified, the speed of popularizing the internet service may be accelerated, the user may experience the latest internet service faster and better, and the coverage of the internet service provided by the IM application may be significantly improved. Further, the plug-in may not be encapsulated into the IM application and may not be downloaded together with the IM application, thus network traffic of the user may be effectively reduced, and the user costs may be saved.

Those skilled in the art may understand that all or part of the procedures of the methods of the above examples may be implemented by hardware modules following machine readable instructions of a computer program. The computer program may be stored in a computer readable storage medium. When running, the computer program may provide the procedures of the method examples. The storage medium may be diskette, CD, ROM (Read-Only Memory), or RAM (Random Access Memory), etc.

The above are several examples of the present disclosure, and are not used for limiting the protection scope of the present disclosure. Any modifications, equivalents, improvements, etc., made under the principle of the present disclosure should be included in the protection scope of the present disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for upgrading a plug-in based on an instant messaging (IM) application, comprising:
obtaining basic elements of an IM application with a version called by a plug-in to be upgraded of the IM application;
obtaining basic elements of an IM application in a client;
comparing, according to a type of a basic element, the basic elements of the IM application with the version called by the plug-in to be upgraded with the basic elements of the IM application in the client;
determining a client matching the basic elements of the IM application with the version called by the plug-in to be upgraded; and
releasing the plug-in to be upgraded to the matched client.

2. The method of claim 1, wherein the basic elements comprise an export function, an interface, an enumeration value, and a struct.

3. The method of claim 2, wherein the operation of obtaining the basic elements of the IM application comprises:
scanning a server to obtain a dynamic link library (DLL) file in the IM application;
analyzing a structure of a portable execute (PE) file in the DLL file, extracting information about an export table from the structure, and obtaining the export function; and
scanning, using an automatic interface of a data terminal equipment (DTE) in the server, all files of the IM application in the server to obtain the interface, the enumeration value, and the struct.

4. The method of claim 3, wherein
the operation of scanning the server to obtain the DLL file in the IM application comprises:
scanning, through calling a scanning function, a DLL file in the server to obtain the DLL file in the IM application;
the operation of scanning, using the automatic interface of the DTE in the server, all the files of the IM application in the server to obtain the interface, the enumeration value, and the struct comprises:
scanning, through calling a source code scanning function by the automatic interface of the DTE, all the files of the IM application in the server to obtain the interface, the enumeration value, and the struct.

5. The method of claim 1, further comprising:
storing the basic elements of the IM application with the version called by the plug-in to be updated; and
storing the basic elements of the IM application in the client and identifier information of the client.

6. The method of claim 5, wherein the operations of comparing, according to the type of the basic element, the basic elements of the IM application with the version called by the plug-in to be upgraded with the basic elements of the IM application in the client, and determining the matched client comprise:
obtaining an export function, an interface, an enumeration value, and a struct in the basic elements of the IM application with the version called by the plug-in to be upgraded;
obtaining an export function, an interface, an enumeration value, and a struct in the basic elements of the IM application in the client;
respectively comparing the export function, the interface, the enumeration value, and the struct in the basic elements of the IM application with the version called by the plug-in to be upgraded with the export function, the interface, the enumeration value, and the struct in the basic elements of the IM application in the client;
determining that export function match is successful, interface match is successful, enumeration value match is successful, and struct match is successful;
determining a client IM application matching the basic elements of the IM application with the version called by the plug-in to be upgraded; and
obtaining, based on the client IM application matching the basic elements of the IM application with the version called by the plug-in to be upgraded, identifier information about the matched client on which the client IM application is installed.

7. The method of claim 6, wherein the operation of determining that the export function match is successful comprises:
comparing a parameter of the export function in the IM application with the version called by the plug-in to be upgraded with a parameter of the export function in the IM application in the client; and
determining, in response to a determination that the parameter of the export function in the IM application with the version called by the plug-in to be upgraded is the same as the parameter of the export function in the IM application in the client, that the export function match is successful;
wherein the parameter of the export function comprises a function name, a return value, the number of the parameter, and a parameter type.

8. The method of claim 6, wherein the operation of determining that the interface match is successful comprises:
comparing a name of the interface in the IM application with the version called by the plug-in to be upgraded with a name of the interface in the IM application in the client;
comparing, in response to a determination that the name of the interface in the IM application with the version called by the plug-in to be upgraded is the same as the name of the interface in the IM application in the client, a member function of the interface in the IM application with the version called by the plug-in to be upgraded with a member function of the interface in the IM application in the client; and
determining, in response to a determination that the member function of the interface in the IM application with the version called by the plug-in to be upgraded is the same as the member function of the interface in the IM application in the client, that the interface match is successful.

9. The method of claim 6, wherein the operation of determining that the enumeration value match is successful comprises:
respectively comparing a position and a value of a enumeration member in the enumeration value of the IM application with the version called by the plug-in to be upgraded with a position and a value of a enumeration member in the enumeration value of the IM application in the client; and
determining, in response to a determination that the position and the value of the enumeration member in the IM application with the version called by the plug-in to be upgraded are respectively the same as the position and the value of the enumeration member in the IM application in the client, that the enumeration value match is successful.

10. The method of claim 6, wherein the operation of determining that the struct match is successful comprises:
comparing a type, a member name, and a position of a struct member in the IM application with the version called by the plug-in to be upgraded with a type, a member name, and a position of a struct member in the IM application in the client; and
determining, in response to a determination that the type, the member name, and the position of the struct member in the IM application with the version called by the plug-in to be upgraded are respectively the same as the type, the member name, and the position of the struct member in the IM application in the client, that the struct match is successful.

11. The method of claim 1, wherein the operation of releasing the plug-in to be upgraded to the matched client comprises:
sending to the matched client a prompt message about the plug-in to be upgraded;
receiving, from a client belonging to the matched client, a confirmation message in response to the prompt message about the plug-in to be upgraded; and
sending the plug-in to be upgraded to the client sending the confirmation message.

12. An apparatus for upgrading a plug-in based on an instant messaging (IM) application, comprising:
an obtaining module, to obtain basic elements of an IM application with a version called by a plug-in to be upgraded of the IM application;
a scanning module, to obtain basic elements of an IM application in a client;
a matching module, to compare, according to a type of a basic element, the basic elements of the IM application with the version called by the plug-in to be upgraded with the basic elements of the IM application in the client, and to determine a client matching the basic elements of the IM application with the version called by the plug-in to be upgraded; and
a releasing module, to release the plug-in to be upgraded to the matched client.

13. The apparatus of claim 12, further comprising:
a storing module, to store the basic elements of the IM application with the version called by the plug-in to be updated, and to store the basic elements of the IM application in the client and identifier information of the client;
wherein the basic elements comprise an export function, an interface, an enumeration value, and a struct.

14. The apparatus of claim 13, wherein the scanning module further comprises:
a first scanning sub-module, to scan a server and the client, obtain a dynamic link library (DLL) file in the IM application, analyze a structure of a portable execute (PE) file in the DLL file, extract information about an export table from the structure, and obtain the export function; and
a second scanning sub-module, to traverse the server and the client, scan, using an automatic interface of a data terminal equipment (DTE) in the server, all files of the IM application to obtain the interface, the enumeration value, and the struct.

15. The apparatus of claim 14, wherein the matching module further comprises:
an export function matching sub-module, to obtain, from the storing module, an export function in the basic elements of the IM application with the version called by the plug-in to be upgraded and an export function in the basic elements of the IM application in the client, compare the obtained export functions, and transmit a result of comparing the obtained export functions to a match result processing sub-module;
an interface matching sub-module, to obtain, from the storing module, an interface in the basic elements of the IM application with the version called by the plug-in to be upgraded and an interface in the basic elements of the IM application in the client, compare the obtained interfaces, and transmit a result of comparing the obtained interfaces to the match result processing sub-module;
an enumeration value matching sub-module, to obtain, from the storing module, an enumeration value in the basic elements of the IM application with the version called by the plug-in to be upgraded and an enumeration value in the basic elements of the IM application in the client, compare the obtained enumeration values, and transmit a result of comparing the obtained enumeration values to the match result processing sub-module;
a struct matching sub-module, to obtain, from the storing module, a struct in the basic elements of the IM application with the version called by the plug-in to be upgraded and a struct in the basic elements of the IM application in the client, compare the obtained structs, and transmit a result of comparing the obtained structs to the match result processing sub-module; and
the match result processing sub-module, to determine that the received results are all match, obtain, based on the basic elements of the IM application in the client and the identifier information of the client stored in the storing module, identifier information of a client corresponding to the received results and matching the basic elements of the IM application with the version called by the plug-in to be upgraded, and transmit the obtained identifier information of the matched client to the releasing module.

16. A non-transitory computer readable storage medium storing one or more programs, the one or more programs comprising instructions that when executed by one or more computers cause the one or more computers to perform operations comprising:
obtaining basic elements of an IM application with a version called by a plug-in to be upgraded of the IM application;
obtaining basic elements of an IM application in a client;
comparing, according to a type of a basic element, the basic elements of the IM application with the version called by the plug-in to be upgraded with the basic elements of the IM application in the client;
determining a client matching the basic elements of the IM application with the version called by the plug-in to be upgraded; and
releasing the plug-in to be upgraded to the matched client.
